(19) United States
(12) Patent Application Publication
(10) Pub. No.: US 2025/0085404 A1
(43) Pub. Date: Mar. 13, 2025

(54) RANGE IMAGING APPARATUS AND RANGE IMAGING METHOD

(71) Applicant: TOPPAN HOLDINGS INC., Tokyo (JP)

(72) Inventors: Kazuto YAMAMOTO, Taito-ku (JP); Tomoyuki AKAHORI, Taito-ku (JP); Tomohiro NAKAGOME, Taito-ku (JP)

(73) Assignee: TOPPAN HOLDINGS INC., Tokyo (JP)

(21) Appl. No.: 18/956,053

(22) Filed: Nov. 22, 2024

Related U.S. Application Data
(63) Continuation of application No. PCT/JP2023/019366, filed on May 24, 2023.

(30) Foreign Application Priority Data
May 24, 2022 (JP) 2022-084758

(51) Int. Cl. G01S 7/4863; G01S 17/894

(52) U.S. Cl. CPC G01S 7/4863; G01S 17/894

(57) ABSTRACT

A range imaging apparatus includes a light source unit, a light receiving unit having pixel circuits formed in a two-dimensional matrix and a pixel driver circuit, and a range computing unit that calculates the distance to a subject based on the amount of charge stored in each charge storage. The light pulse is structured light made up of light dots, and the range computing unit calculates the distance to the subject by using a value obtained by subtracting, from a first amount of charge stored in the charge storage in a first pixel circuit that receives directly reflected light, a second amount of charge based on an amount of charge stored in the charge storage in a second pixel circuit that is located near the first pixel circuit and does not receive the directly reflected light.

### CROSS-REFERENCE TO RELATED APPLICATIONS

The present application is a continuation of and claims the benefit of priority to International Application No. PCT/JP2023/019366, filed May 24, 2023, which is based upon and claims the benefit of priority to Japanese Application No. 2022-084758, filed May 24, 2022. The entire contents of these applications are incorporated herein by reference.

### BACKGROUND OF THE INVENTION

### Field of the Invention

The present invention relates to a range imaging apparatus and a range imaging method.

### Description of Background Art

Time-of-flight (hereinafter referred to as “TOF”) range imaging apparatuses use the speed of light to measure the distance between the measurement device and an object based on the time of flight of light in a space (measurement space) (see, for example, JP 4235729 B). The entire contents of this publication are incorporated herein by reference.

### SUMMARY OF THE INVENTION

According to one aspect of the present invention, a range imaging apparatus includes a light source that emits a light pulse to a subject, a light receiving unit including pixel circuits and a pixel driver circuit, and a range computing unit including circuitry that calculates a distance to the subject based on an amount of charge. The pixel circuits in the light receiving unit are formed in a two-dimensional matrix and have a photoelectric conversion device configured to generate charge corresponding to incident light and charge storages that store the charge such that the charge storages are N charge storages where the N≥3, the pixel driver circuit in the light receiving unit distributes and stores the charge into the charge storages at a storage timing synchronized with emission of the light pulse, the circuitry of the range computing unit calculates the distance to the subject based on the amount of charge stored in each of the charge storages, the light pulse is structured light including light dots, and the circuitry of the range computing unit calculates the distance to the subject by using a value obtained by subtracting a second amount of charge based on an amount of charge stored in a second one of the charge storages in a second pixel circuit of the pixel circuits from a first amount of charge stored in a first one of the charge storages in a first pixel circuit of the pixel circuits such that the first pixel circuit receives directly reflected light and the second pixel circuit is formed near the first pixel circuit and does not receive the directly reflected light.

According to another aspect of the present invention, a range imaging method includes emitting a light pulse to a subject from a light source of a range imaging apparatus, and calculating a distance to the subject by using a range computing unit of the range imaging apparatus. The range imaging apparatus includes the light source that emits the light pulse to the subject, a light receiving unit including pixel circuits and a pixel driver circuit, and the range computing unit including circuitry that calculates the distance to the subject based on an amount of charge, the pixel circuits in the light receiving unit are formed in a two-dimensional matrix and have a photoelectric conversion device that generates charge corresponding to incident light and charge storages that store the charge such that the charge storages are N charge storages where the N≥3, the pixel driver circuit in the light receiving unit distributes and stores the charge into the charge storages at a storage timing synchronized with emission of the light pulse, the circuitry of the range computing unit calculates the distance to the subject based on the amount of charge stored in each of the charge storages, the light pulse is structured light including light dots, and the circuitry of the range computing unit calculates the distance to the subject by using a value obtained by subtracting a second amount of charge based on an amount of charge stored in a second one of the charge storages in a second pixel circuit of the pixel circuits from a first amount of charge stored in a first one of the charge storages in a first pixel circuit of the pixel circuits such that the first pixel circuit receives directly reflected light and the second pixel circuit is formed near the first pixel circuit and does not receive the directly reflected light.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram illustrating a schematic configuration of the range imaging apparatus according to an embodiment;

FIG. 2 is a block diagram illustrating a schematic configuration of a range image sensor according to the embodiment;

FIG. 3 is a circuit diagram illustrating an exemplary configuration of a pixel according to the embodiment;

FIG. 4 is a diagram for illustrating directly reflected light RLd and multipath reflected light RLm according to the embodiment;

FIG. 5 is a diagram showing an example of light received by the light receiving region according to the embodiment;

FIG. 6A is a diagram showing an example of a pixel that has received the directly reflected light RLd according to the embodiment;

FIG. 6B is a diagram showing an example of a pixel that does not receive the directly reflected light RLd according to the embodiment;

FIG. 7 is a diagram illustrating the weighting process performed in this embodiment;

FIG. 8A is a diagram showing an example of light received by the light receiving region according to the embodiment;

FIG. 8B is a diagram showing the variation in the amount of light received by each pixel in FIG. 8A; and

FIG. 9 is a flowchart illustrating the flow of a process performed by the range imaging apparatus according to the embodiment.

### DETAILED DESCRIPTION OF THE EMBODIMENTS

Embodiments will now be described with reference to the accompanying drawings, wherein like reference numerals designate corresponding or identical elements throughout the various drawings.

A range imaging apparatus according to an embodiment will be described below with reference to the drawings.

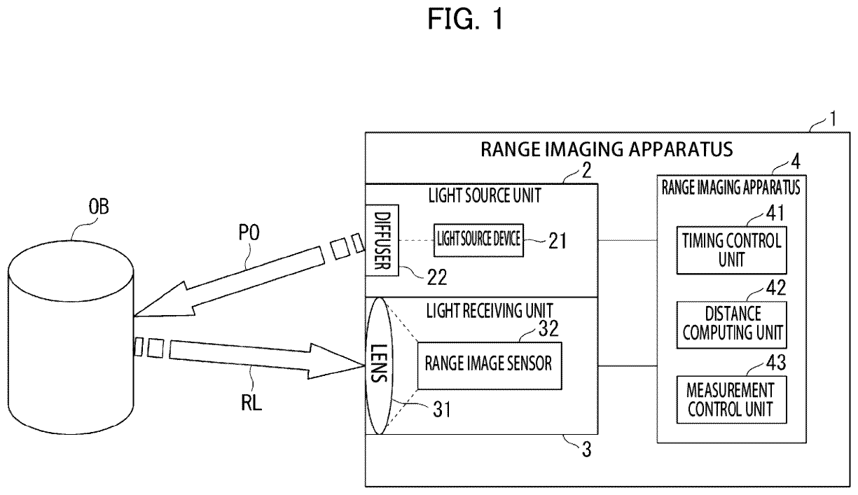

FIG. 1 is a block diagram illustrating a schematic configuration of a range imaging apparatus according to an embodiment of the present invention. The range imaging apparatus 1 includes, for example, a light source unit 2, a light receiving unit 3, and a range image processing unit 4. FIG. 1 also illustrates a subject OB the distance to which will be measured by the range imaging apparatus 1.

In response to a control procedure performed by the range image processing unit 4, the light source unit 2 emits a light pulse PO into a measurement space in which the subject OB exists the distance to which is to be measured by the range imaging apparatus 1. The light source unit 2 may be, for example, a surface-emitting semiconductor laser module such as a vertical-cavity surface-emitting laser (VCSEL). The light source unit 2 includes a light source device 21 and a diffuser 22.

The light source device 21 is a light source that emits a laser beam in a near-infrared wavelength band (for example, a wavelength band in which the wavelength is 850 nm to 940 nm), which serves as the light pulse PO projected to the subject OB. The light source device 21 may be, for example, a semiconductor laser light-emitting device. The light source device 21 emits a pulsed laser beam in response to the control procedure performed by a timing control unit 41.

The diffuser 22 is an optical component that diffuses the laser beam in a near-infrared wavelength band emitted from the light source device 21 over an area in which the subject OB is irradiated with the diffused laser beam. The pulsed laser beam diffused by the diffuser 22 is output as the light pulse PO and projected to the subject OB.

The light receiving unit 3 receives reflected light RL of the light pulse PO reflected from the subject OB the distance to which will be measured by the range imaging apparatus 1 and outputs a pixel signal corresponding to the received reflected light RL. The light receiving unit 3 includes a lens 31 and a range image sensor 32.

The lens 31 is an optical lens that introduces the reflected light RL that is incident on the lens 31 to the range image sensor 32. The lens 31 outputs the reflected light RL that is incident on the lens 31 toward the range image sensor 32 and causes pixels provided in a light-receiving region of the range image sensor 32 to receive the reflected light RL (or makes the reflected light RL incident on the pixels).

The range image sensor 32 is an imaging element used in the range imaging apparatus 1. The range image sensor 32 includes pixels in a two-dimensional light-receiving region. Each pixel of the range image sensor 32 includes a single photoelectric conversion device, charge storages corresponding to the single photoelectric conversion device, and a component that distributes electric charge to the charge storages. That is, the pixels are imaging elements of a distributing structure that distributes and stores the electric charge to the charge storages.

The range image sensor 32 distributes the electric charge generated by the photoelectric conversion device to each charge storage in response to the control procedure performed by the timing control unit 41. Additionally, the range image sensor 32 outputs a pixel signal corresponding to the amount of charge that has been distributed to each charge storage. The range image sensor 32 includes multiple pixels formed in a two-dimensional matrix and outputs a pixel signal for one frame corresponding to each pixel.

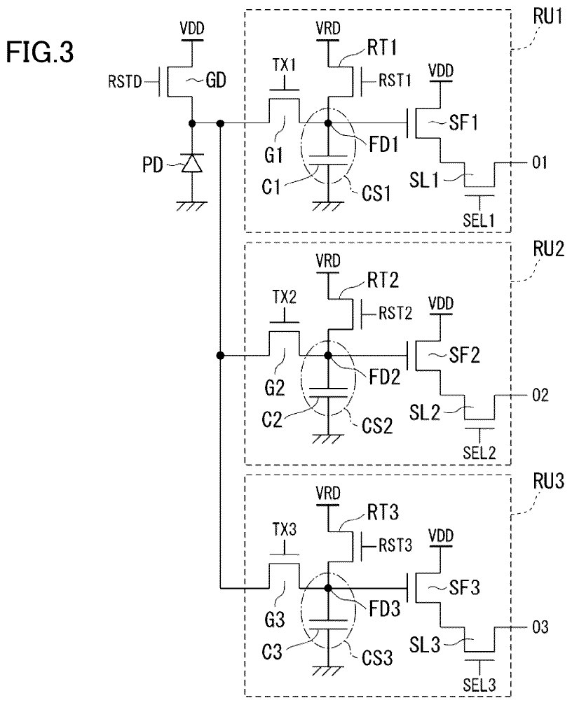

The range image processing unit 4 controls the range imaging apparatus 1 to compute the distance to the subject OB. The range image processing unit 4 includes the timing control unit 41, a range computing unit 42, and a measurement control unit 43. The timing control unit 41 controls the timings at which a variety of control signals required for the measurement are output in response to the control procedure performed by the measurement control unit 43. The variety of signals as used herein refer to, for example, a signal for controlling the emission of the light pulse PO, a signal for distributing and storing the reflected light RL to the charge storages, and a signal for controlling the storage count per frame. The storage count is the number of times the process of distributing and storing charge to the charge storages CS (see FIG. 3) is repeated. The product of the storage count and a duration (storage duration) for which charge is stored in the charge storages during each process of distributing and storing charge is an exposure time.

The range computing unit 42 outputs distance information obtained by calculating the distance to the subject OB, based on the pixel signal output from the range image sensor 32. The range computing unit 42 calculates the delay time from the time at which the light pulse PO is emitted to the time at which the reflected light RL is received, based on the amount of charge stored in the charge storages. The range computing unit 42 calculates the distance to the subject OB in accordance with the calculated delay time.

The measurement control unit 43 controls the timing control unit 41. For example, the measurement control unit 43 sets the storage count per frame and the storage duration to control the timing control unit 41 so that image capture is performed according to the settings.

With this configuration, the range imaging apparatus 1 causes the light source unit 2 to emit the light pulse PO in the near-infrared wavelength band to the subject OB, causes the light receiving unit 3 to receive the reflected light RL reflected from the subject OB, and causes the range image processing unit 4 to measure the distance to the subject OB and output it as the distance information.

FIG. 1 shows the range imaging apparatus 1 in which the range image processing unit 4 is included; however, the range image processing unit 4 may be a component provided externally from the range imaging apparatus 1.

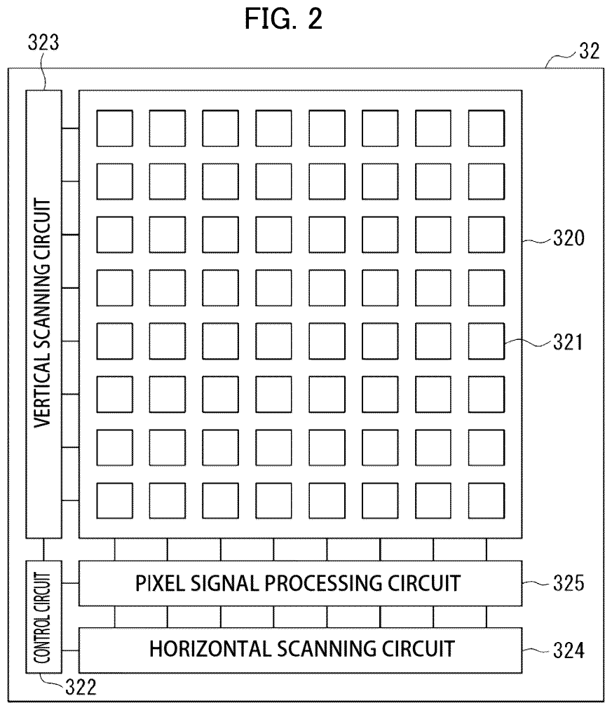

Next, a configuration of the range image sensor 32 used as an imaging element in the range imaging apparatus 1 will be described with reference to FIG. 2. FIG. 2 is a block diagram illustrating the schematic configuration of the imaging element (range image sensor 32) used in the range imaging apparatus 1 of the embodiment.

As illustrated in FIG. 2, the range image sensor 32 includes, for example, a light-receiving region 320, which includes multiple pixels 321, a control circuit 322, a vertical scanning circuit 323, which has distribution operation, a horizontal scanning circuit 324, and a pixel signal processing circuit 325.

The light-receiving region 320 is a region in which the pixels 321 are formed. FIG. 2 illustrates an example in which the pixels 321 are formed in a two-dimensional matrix of 8 rows and 8 columns. The pixels 321 store charge corresponding to the amount of light received. The control circuit 322 performs overall control of the range image sensor 32. For example, the control circuit 322 controls the operation of the components of the range image sensor 32 according to instructions from the timing control unit 41 of the range image processing unit 4. The components of the range image sensor 32 may be directly controlled by the timing control unit 41, in which case the control circuit 322 may be omitted.

The vertical scanning circuit 323 is a circuit that controls the pixels 321 formed in the light-receiving region 320 row by row in response to the control procedure performed by the control circuit 322. The vertical scanning circuit 323 causes the pixel signal processing circuit 325 to output a voltage signal corresponding to the amount of charge accumulated in each of the charge storages CS of each pixel 321. In this case, the vertical scanning circuit 323 distributes and stores the charge converted by the photoelectric conversion device to each of the charge storages of each pixel 321. That is, the vertical scanning circuit 323 is an example of a “pixel driver circuit”. Specifically, the vertical scanning circuit 323 distributes and accumulates the electric charge in the charge storages CS at the storage timings synchronized with the emission of the light pulse PO.

The pixel signal processing circuit 325 is a circuit that performs predetermined signal processing (for example, noise suppression and A/D conversion) on voltage signals output from the pixels 321 of each column to a corresponding vertical signal line in response to the control procedure performed by the control circuit 322.

The horizontal scanning circuit 324 is a circuit that sequentially outputs, to a horizontal signal line, the signal output from the pixel signal processing circuit 325 in response to the control procedure performed by the control circuit 322. Accordingly, the pixel signal corresponding to the amount of charge accumulated per frame is sequentially output to the range image processing unit 4 via the horizontal signal line.

The following description is based on a precondition that the pixel signal processing circuit 325 has performed A/D conversion, so that the pixel signal is a digital signal.

The configuration of the pixels 321 formed in the light-receiving region 320 of the range image sensor 32 will now be described with reference to FIG. 3. FIG. 3 is a circuit diagram illustrating an exemplary configuration of the pixels 321 formed in the light-receiving region 320 of the range image sensor 32 according to the embodiment. FIG. 3 illustrates an exemplary configuration of one of the pixels 321 formed in the light-receiving region 320. The pixel 321 is an exemplary configuration including three pixel signal readout units.

The pixel 321 includes a single photoelectric conversion device PD, drain gate transistors GD, and three pixel signal readout units RU each of which outputs a voltage signal from the corresponding output terminal O. The pixel signal readout units RU each include a readout gate transistor G, a floating diffusion FD, a charge storage capacitor C, a reset gate transistor RT, a source follower gate transistor SF, and a selection gate transistor SL. In each pixel signal readout unit RU, the floating diffusion FD and the charge storage capacitor C constitute a charge storage CS.

In FIG. 3, a numerical value “1”, “2”, or “3” is appended after the reference sign “RU” of the three pixel signal readout units RU to distinguish the pixel signal readout units RU from one another. Similarly, the numerical values are also appended after the reference signs of the components of the three pixel signal readout units RU to express the components by distinguishing the pixel signal readout units RU with which they are associated.

In the pixel 321 shown in FIG. 3, the pixel signal readout unit RU1 that outputs a voltage signal from an output terminal O1 includes a readout gate transistor G1, a floating diffusion FD1, a charge storage capacitor C1, a reset gate transistor RT1, a source follower gate transistor SF1, and a selection gate transistor SL1. In the pixel signal readout unit RU1, the floating diffusion FD1 and the charge storage capacitor C1 constitute a charge storage CS1. The pixel signal readout units RU2 and RU3 also have the same configuration.

The photoelectric conversion device PD is an embedded photodiode that performs photoelectric conversion of the incident light to generate electric charge and accumulates the generated electric charge. The photoelectric conversion device PD may have any configuration. The photoelectric conversion device PD may be, for example, a PN photodiode including a P-type semiconductor and an N-type semiconductor joined together or a PIN photodiode including an I-type semiconductor sandwiched between a P-type semiconductor and an N-type semiconductor. The photoelectric conversion device PD is not limited to a photodiode and may be, for example, a photogate-type photoelectric conversion device.

In each pixel 321, the charge generated by the photoelectric conversion of the incident light performed by the photoelectric conversion device PD is distributed to the three charge storages CS. Voltage signals each corresponding to the amount of charge that has been distributed are output to the pixel signal processing circuit 325.

The configuration of the pixels formed in the range image sensor 32 is not limited to the configuration including three pixel signal readout units RU as illustrated in FIG. 3 and may be any configuration including multiple pixel signal readout units RU. That is, the number of the pixel signal readout units RU (charge storages CS) included in each pixel located in the range image sensor 32 may be two, or four or more.

Further, the pixel 321 configured as illustrated in FIG. 3 shows an exemplary configuration in which each charge storage CS includes the floating diffusion FD and the charge storage capacitor C. However, each charge storage CS may have any configuration as long as at least the floating diffusion FD is included, and each pixel 321 does not need to include the charge storage capacitor C.

Although the pixel 321 having the configuration shown in FIG. 3 shows an exemplary configuration including drain gate transistors GD, the drain gate transistors GD may not be provided if there is no need to discard the charge stored (remaining) in the photoelectric conversion device PD.

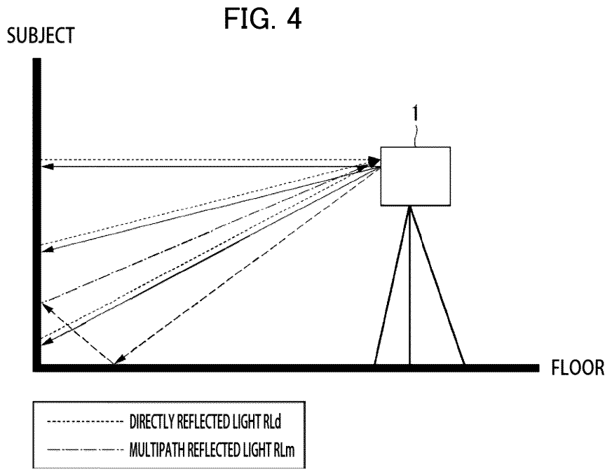

FIG. 4 is a diagram for illustrating directly reflected light RLd and multipath reflected light RLm according to this embodiment. FIG. 4 schematically shows how the range imaging apparatus 1 emits the light pulse PO onto the subject OB. As shown in FIG. 4, the reflected light RL received by the range imaging apparatus 1 includes the directly reflected light RLd and the multipath reflected light RLm. That is, part of the light pulse PO emitted by the range imaging apparatus 1 reaches the range image pickup device 1 after being reflected from the subject OB and is received by the light receiving unit 3 as the directly reflected light RLd. On the other hand, another part of the light pulse PO emitted by the range imaging apparatus 1 is reflected from the subject OB after being reflected from the floor or the like, reaches the range imaging apparatus 1, and then is received by the light receiving unit 3 as the multipath reflected light RLm. Such multipath reflected light RLm travels a longer optical path than the directly reflected light RLd before being received by the light receiving unit 3, and thus is received later than the directly reflected light RLd, which makes it difficult to calculate the distance correctly. To address this issue, in this embodiment, the light source unit 2 uses dot light as the light source for irradiation. A dot light source is structured light made up of light dots. By using the dot light source, a non-uniform local light pulse PO is emitted to the subjects OB.

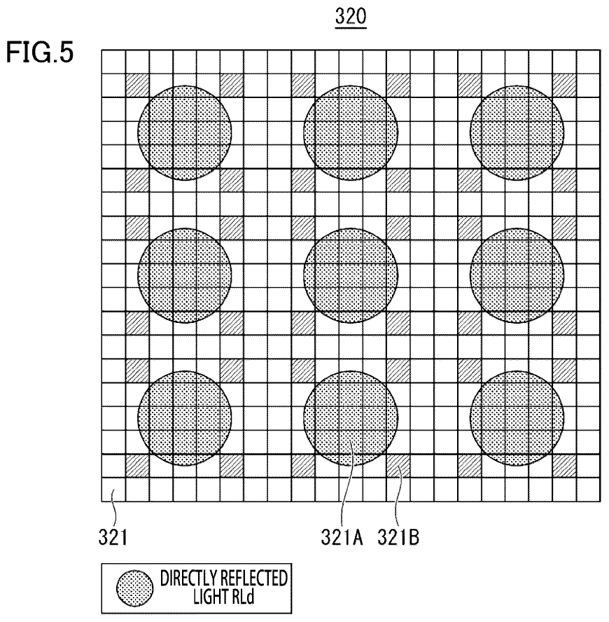

FIG. 5 is a diagram showing an example of light received by the light-receiving region 320 according to the embodiment. As shown in FIG. 5, when the dot light source is used, there are areas on the subject OB that are irradiated with light dots and areas that are not irradiated with them, and the pixels 321 in the light receiving region 320 of the light receiving unit 3 can be classified into two types of pixels, namely, pixels 321A that receive light from areas on the subject OB that are irradiated with the light dots, and pixels 321B that do not receive light. The pixels 321A are an example of a “first pixel circuit”. The pixels 321B are an example of a “second pixel circuit”.

When a dot light source is used, the pixels 321A receive reflected light from the subject OB. On the other hand, it can also be considered that the pixels 321B do not receive reflected light from the subject OB. However, in reality, light that reached the subject OB after being reflected by the floor, wall surface, or the like is received by the range imaging apparatus 1 as multipath reflected light RLm. Such multipath reflected light RLm is one of the causes of errors in distance calculation.

When there is multipath reflected light RLm, by using the dot light source, the pixels 321A receive a mixture of the reflected light from the subject OB and the multipath reflected light RLm, and the pixels 321B receive only the multipath reflected light RLm. The present embodiment utilizes this property to reduce the influence of the multipath reflected light RLm by subtracting the amount of light received by a pixel 321B from the amount of light received by a pixel 321A.

More specifically, the range computing unit 42 subtracts a signal value corresponding to the amount of charge stored in a charge storage CS of pixel 321B from a signal value corresponding to the amount of charge stored in the charge storage CS of the pixel 321A. The range computing unit 42 performs processing calculation using the value after subtraction. This makes it possible to calculate the distance using a signal corresponding only to the directly reflected light RLd that does not include the multipath reflected light RLm so that the influence of the multipath reflected light RLm can be suppressed.

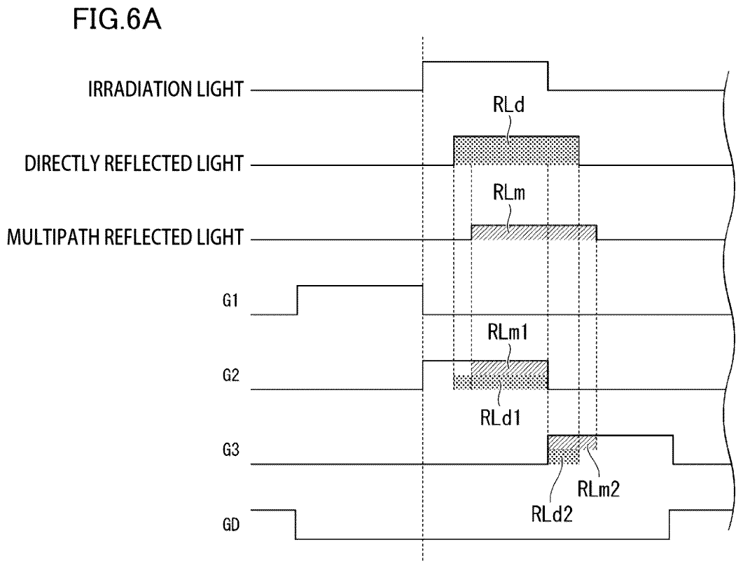

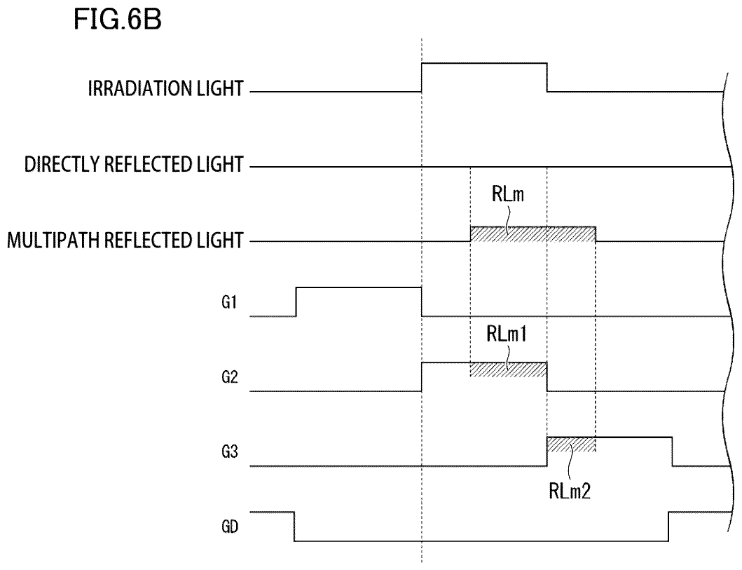

FIGS. 6A and 6B show timing charts for the pixel 321. FIGS. 6A and 6B each show the timing at which the irradiation light (light pulse PO) is emitted, the timings at which the directly reflected light RLd and the multi-path reflected light RLm are received, and the timing at which the pixel 321 is driven. As the timing at which the pixel 321 is driven, a driving signal TX1 for driving the readout gate transistor G1 in the pixel 321 is denoted by “G1”, a driving signal TX2 for driving a readout gate transistor G2 is denoted by “G2”, a driving signal TX3 for driving a readout gate transistor G3 is denoted by “G3”, and a driving signal RSTD for driving the drain gate transistor GD is denoted by “GD”. FIGS. 6A and 6B are timing charts illustrating the timing at which the pixel 321A is driven.

At the same timing as when the light pulse PO is emitted, the vertical scanning circuit 323 brings the drain gate transistor GD into an off state and brings the readout gate transistor G1 into an on state. After keeping the readout gate transistor G1 in the on state for a time corresponding to the storage duration Ta, the vertical scanning circuit 323 brings the readout gate transistor G1 into the off state. Thus, while the readout gate transistor G1 is controlled to be in the on state, the electric charge obtained by photoelectric conversion by the photoelectric conversion device PD is accumulated in the charge storage CS1 through the readout gate transistor G1.

Next, at the timing at which the readout gate transistor G1 is brought into the off state, the vertical scanning circuit 323 brings the readout gate transistor G2 into the on state for a time corresponding to the storage duration. Thus, while the readout gate transistor G2 is controlled to be in the on state, the electric charge obtained by the photoelectric conversion by the photoelectric conversion device PD is accumulated in the charge storage CS2 through the readout gate transistor G2.

Next, at the timing at which the storage of charge into the charge storage CS2 is finished, the vertical scanning circuit 323 brings the readout gate transistor G3 into the on state for a time corresponding to the storage duration Ta, and then brings the readout gate transistor G3 into the off state. Thus, while the readout gate transistor G3 is controlled to be in the on state, the electric charge obtained by the photoelectric conversion by the photoelectric conversion device PD is accumulated in the charge storage CS3 through the readout gate transistor G3.

At the timing at which the storage of the electric charge to the charge storage CS3 is finished, the vertical scanning circuit 323 brings the drain gate transistor GD into the on state to drain the charge. This allows the charge generated through photoelectric conversion by the photoelectric conversion device PD to be discarded via the drain gate transistor GD.

As shown in FIG. 6A, the multipath reflected light RLm is received with a delay relative to the directly reflected light RLd. In the period in which the gate transistor G2 of the pixel 321A is in the on state, directly reflected light RLd1 (part of the directly reflected light RLd) and multipath reflected light RLm1 (part of the multipath reflected light RLm) are received, and a charge corresponding to the amount of light received is stored in the charge storage CS2. In the period in which the gate transistor G3 of the pixel 321A is in the on state, directly reflected light RLd2 (the remaining part of the directly reflected light RLd) and multipath reflected light RLm2 (the remaining part of the multipath reflected light RLm) are received, and a charge corresponding to the amount of light received is stored in the charge storage CS3. That is, a charge corresponding to the amount of light including the directly reflected light RLd and the multipath reflected light RLm is distributed and stored into the charge storages CS2 and CS3 of the pixel 321A.

As shown in FIG. 6B, the pixel 321B does not receive the directly reflected light RLd and only receives the multipath reflected light RLm. In the period in which the gate transistor G2 of the pixel 321B is in the on state, the multipath reflected light RLm1 is received, and a charge corresponding to the amount of light received is stored in the charge storage CS2. In the period in which the gate transistor G3 of the pixel 321B is in the on state, the multipath reflected light RLm2 is received, and a charge corresponding to the amount of light received is stored in the charge storage CS3. That is, charge corresponding to the amount of the multipath reflected light RLm is distributed and stored into the charge storages CS2 and CS3 of the pixel 321B.

The vertical scanning circuit 323 repeats this storage cycle a predetermined storage count. After repeating the storage cycle for the predetermined storage count, the vertical scanning circuit 323 outputs voltage signals each corresponding to the amount of charge that has been distributed to a charge storage CS. Specifically, the vertical scanning circuit 323 brings the selection gate transistor SL1 into the on state for a predetermined time to output, from the output terminal O1, a voltage signal corresponding to the amount of charge accumulated in the charge storage CS1 through the pixel signal readout unit RU1. Similarly, the vertical scanning circuit 323 sequentially brings the selection gate transistors SL2 and SL3 into the on state to output voltage signals corresponding to the amounts of charge accumulated in the charge storages CS2 and CS3 through output terminals O2 and O3. The voltage signals corresponding to the amounts of charge accumulated in the charge storages CS are output as signal values to the range image processing unit 4 via the pixel signal processing circuit 325 and the horizontal scanning circuit 324.

The range computing unit 42 of the range image processing unit 4 calculates the distance to the subject OB based on the signal values output from the vertical scanning circuit 323. The range computing unit 42 identifies two or more charge storages CS into which charge corresponding to the reflected light RL was distributed and stored, and calculates the distance to the subject OB based on the ratio (distribution ratio) of the amounts of charge distributed to the identified plurality of charge storages CS.

The range computing unit 42 uses the following equation (1) to calculate the amount of charge Q2 from which the influence of the multipath reflected light RLm has been removed. The range computing unit 42 uses equation (2) to calculate the amount of charge Q3 from which the influence of the multipath reflected light RLm has been removed.

$$Q 2 = Q 2 A - Q 2 B \qquad ( 1 )$$

Here, Q2 is the amount of charge stored in the charge storage CS2 as a result of the directly reflected light RLd being distributed, Q2A is the amount of charge stored in the charge storage CS2 of the pixel 321A, and Q2B is the amount of charge stored in the charge storage CS2 of the pixel 321B.

$$Q 3 = Q 3 A - Q 3 B \qquad ( 2 )$$

Here, Q3 is the amount of charge stored in the charge storage CS3 as a result of the directly reflected light RLd being distributed, Q3A is the amount of charge stored in the charge storage CS3 of the pixel 321A, and Q3B is the amount of charge stored in the charge storage CS3 of the pixel 321B.

The range computing unit 42 calculates the delay time Td using the following equation (3).

$$Td = To \times ( Q 2 - Q 1 ) / ( Q 2 + Q 3 - 2 \times Q 1 ) \qquad ( 3 )$$

Q1 is the amount of charge stored in the charge storage CS1 of the pixel 321A or 321B.

Q2 is the amount of charge obtained by equation (1).

Q3 is the amount of charge obtained by equation (2).

The range computing unit 42 multiplies the delay time Td obtained from equation (3) by the speed of light (velocity) to calculate the round-trip distance to and from the subject OB. The range computing unit 42 obtains the distance to the subject OB by halving the round-trip distance calculated above.

As can be seen from the above, in this embodiment, it is possible to calculate the amounts of charge stored in the charge storages CS2 and CS3 minus the amount of charge corresponding to the multipath reflected light RLm, that is, calculate the amount of charge corresponding to the directly reflected light RLd using equations (1) and (2). Therefore, it is possible to suppress the influence of the multipath reflected light RLm and calculate the distance accurately.

Which of the pixels 321 in the light receiving region 320 serve as the pixels 321A and which serve as the pixels 321B is determined according to the positions of the pixels 321. As shown in FIG. 2, pixels 321 are formed in a two-dimensional matrix in the light receiving region 320. For example, based on the dot pattern and dot shape of the dot light source, the range computing unit 42 classifies in advance the pixels 321 formed in the light receiving region 320 into pixels 321 that receive the directly reflected light RLd corresponding to the light dots and pixels 321 that do not receive it. The range computing unit 42 classifies the pixels 321 that receive the directly reflected light RLd corresponding to the light dots as the pixels 321A. A pixel 321 around a pixel 321A is classified as a pixel 321 to be used as a pixel 321B.

The range computing unit 42 may use pixels 321 as the pixels 321B. In this case, the range computing unit 42 calculates the amount of charge Q2B in equation (1) and the amount of charge Q3B in equation (2) using a statistical quantity, such as a simple average or a median, obtained from the amounts of charge stored in the pixels 321 located around the pixel 321A. By using a statistical quantity obtained from the amounts of charge stored in the pixels 321, the influence of noise stored in each pixel 321 can be reduced.

The range computing unit 42 uses the position of the pixel 321A having the charge storage CS with the largest amount of charge as a reference position and selects a pixel 321 located at a position one or more pixels away from the reference position in a diagonal direction as the pixel 321B. Although it depends on the size and shape of the light dots, typically, the directly reflected light RLd corresponding to the light dots is received across pixels 321. Using this nature, the position of the pixel 321 that has stored a charge corresponding to the largest amount of light among the pixels 321 that receive the directly reflected light RLd corresponding to the light dots is set as the reference. For example, the range computing unit 42 sets a pixel 321 located at a position that is a predetermined number of pixels (for example, one pixel) away from the reference position in the diagonal direction as the pixel 321B. The light dots tend to have a circular shape. By selecting a pixel 321 located in a diagonal direction as the pixel 321B, a pixel 321 that is closest to the reference position and does not receive the directly reflected light RLd can be selected as the pixel 321B. The minimum number of pixels in a diagonal direction from the position of the reference pixel 321 to the position of the pixel 321 to be selected may be determined according to the size of the light dots.

Alternatively, the range computing unit 42 may select a pixel 321 located at a position that is one or more pixels away in the horizontal or vertical direction as the pixel 321B. That is, the range computing unit 42 may use the position of the pixel 321A having the charge storage CS with the largest amount of charge as a reference position and select a pixel 321 located at a position one or more pixels away from the reference position in the horizontal or vertical direction as the pixel 321B. Even when the light dots have a non-circular shape like a rectangular shape, by selecting a pixel 321 located in the horizontal or vertical direction as the pixel 321B, a pixel 321 that is closest to the reference position and does not receive the directly reflected light RLd can be selected as the pixel 321B.

In addition, the range computing unit 42 may weight the amounts of charge (amounts of charge Q2B and Q3B) stored in the charge storages CS of each pixel 321B according to the position of the pixel 321 and use the weighted amounts of charge to calculate the distance. For example, it is expected that pixels 321 located in the lower part of the light receiving region 320 are significantly affected by multipath light that arrives after being reflected from the floor. By weighting according to the position of each pixel when the degree of influence of the multipath light varies depending on its position in the light receiving region 320 as in this example, the pixels can be influenced equally by the multipath light.

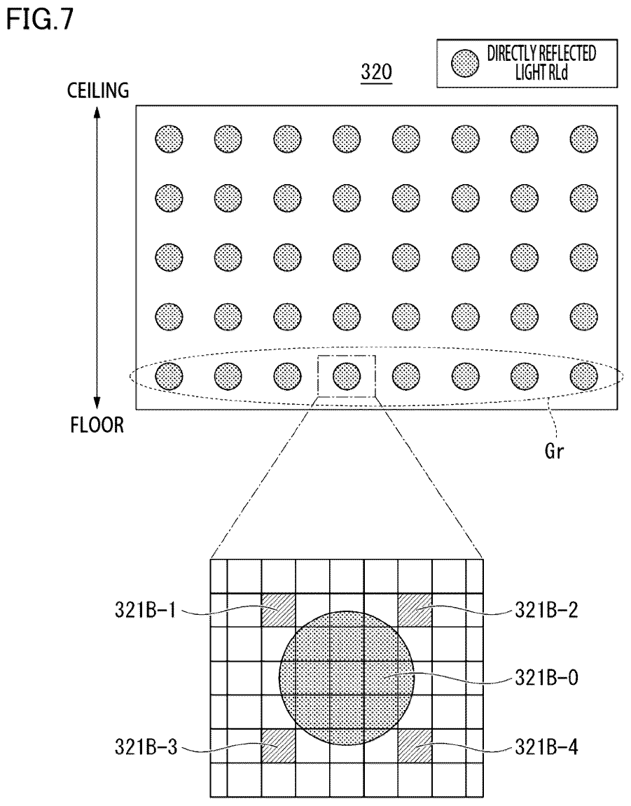

FIG. 7 is a diagram illustrating the weighting process performed in this embodiment. As shown in FIG. 7, the light receiving region 320 includes a group of pixels 321 belonging to a group Gr on the lower side, and the four pixels 321, i.e., pixels 321-1 to 321-4 located in the diagonal directions with respect to the position of a reference pixel 321-0 are used as the pixels 321B.

In this case, among the pixels 321 belonging to the group Gr, the pixels 321-3 and 321-4 on the lower side are expected to be more affected by the multipath light than the pixels 321-1 and 321-2 on the upper side. In such a case, the range computing unit 42 calculates the amount of charge Q2B by applying weighting using, for example, the following equation (4). It also calculates the amount of charge Q3B by applying weighting using, for example, the following equation (5).

$$Q 2 B = Q 2 B 1 \times α1 + Q 2 B 2 \times α2 + Q 2 B 3 \times α3 + Q 2 B 4 \times α4 \qquad ( 4 )$$

Here, Q2B is the amount of charge stored in the charge storage CS2 determined through weighting. Q2B1 is the amount of charge stored in the charge storage CS2 of the pixel 321-1. Q2B2 is the amount of charge stored in the charge storage CS2 of the pixel 321-2. Q2B3 is the amount of charge stored in the charge storage CS2 of the pixel 321-3. Q2B4 is the amount of charge stored in the charge storage CS2 of the pixel 321-4. α1 is a weighting coefficient by which the amount of charge Q2B1 is multiplied. α2 is a weighting coefficient by which the amount of charge Q2B2 is multiplied. α3 is a weighting coefficient by which the amount of charge Q2B3 is multiplied. α4 is a weighting coefficient by which the amount of charge Q2B4 is multiplied.

The coefficients a (coefficients α1 to α4) are set so that their sum has a specific value (for example, 1). The coefficients by which the upper pixels 321 are multiplied (coefficients α1 and α2) are set to values smaller than the coefficients by which the lower pixels 321 are multiplied (coefficients α3 and α4). For example, the coefficients are set as follows: α1=⅛, α2=⅛, α3=⅜, and α4=⅜.

$$Q 3 B = Q 3 B 1 \times β1 + Q 3 B 2 \times β2 + Q 3 B 3 \times β3 + Q 3 B 4 \times β4 \qquad ( 5 )$$

Here, Q3B is the amount of charge stored in the charge storage CS3 determined through weighting. Q3B1 is the amount of charge stored in the charge storage CS3 of the pixel 321-1. Q3B2 is the amount of charge stored in the charge storage CS3 of the pixel 321-2. Q3B3 is the amount of charge stored in the charge storage CS3 of the pixel 321-3. Q3B4 is the amount of charge stored in the charge storage CS3 of the pixel 321-4. β1 is a weighting coefficient by which the amount of charge Q3B1 is multiplied. β2 is a weighting coefficient by which the amount of charge Q3B2 is multiplied. β3 is a weighting coefficient by which the amount of charge Q3B3 is multiplied. β4 is a weighting coefficient by which the amount of charge Q3B4 is multiplied.

The coefficients β (β1 to β4) may be the same as or different from the coefficients α. The coefficients β are set so that their sum has a specific value (for example, 1). The coefficients by which the upper pixels 321 are multiplied (coefficients β1 and β2) are set to values smaller than the coefficients by which the lower pixels 321 are multiplied (coefficients β3 and β4). For example, the coefficients are set as follows: β1=⅛, β2=⅛, β3=⅜, and β4=⅜.

As can be seen from the above, when pixels 321B (pixels 321-1 to 321-4) are used in the range computing unit 42 of the embodiment, the amounts of charge stored in the charge storages CS of each of the pixels 321B (pixels 321-1 to 321-4) are weighted according to the position of the pixel 321B (pixels 321-1 to 321-4) using equations (4) and (5). The range computing unit 42 calculates the amounts of charge Q2B and Q3B using the weighted values. This allows the range computing unit 42 of the embodiment to equalize the influence of the multipath light even when the degree of influence of the multipath light on each pixel 321 varies depending on its position.

In some cases, there are pixels 321 in the light receiving region 320 that receive an amount of light greater than that of the multipath reflected light RLm, even though the pixels should not receive the directly reflected light RLd corresponding to the light dots. This is presumably because multipath light originating from the directly reflected light RLd corresponding to the light dots becomes mixed into the multipath reflected light RLm, which should be mostly multipath light originating from diffused reflected light RL. This phenomenon may occur, for example, when there is a specular-reflective floor or for another reason.

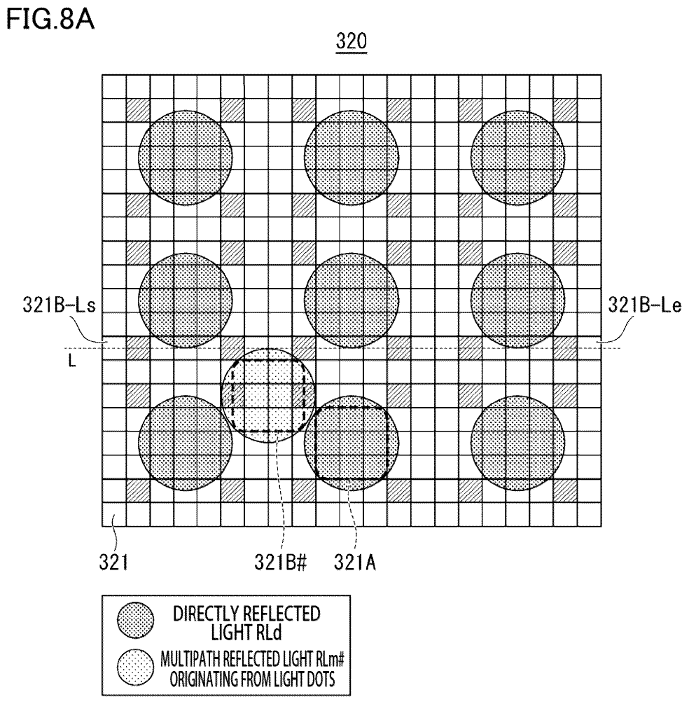

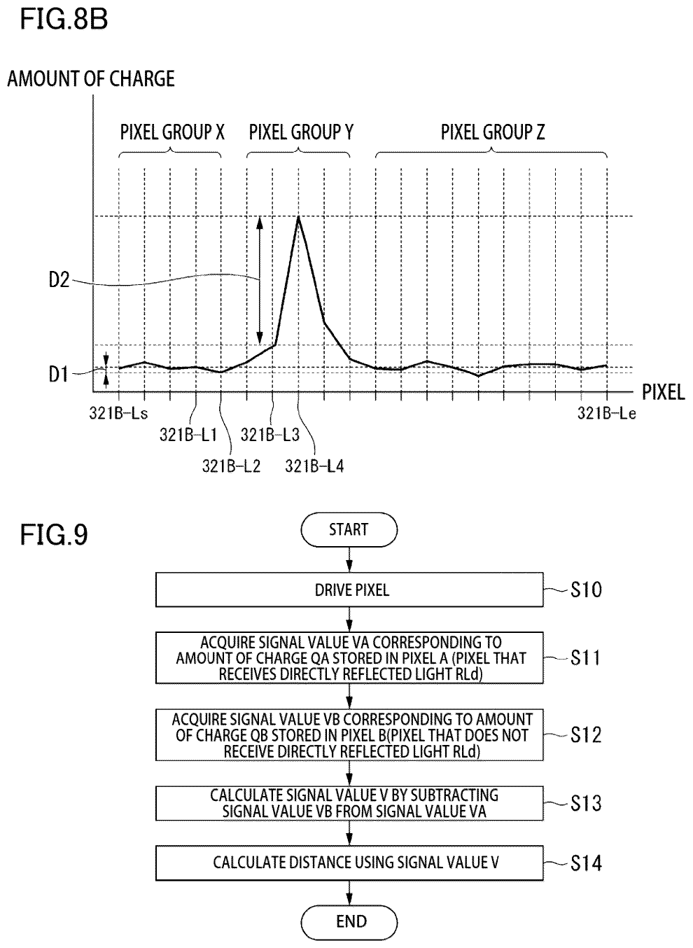

The phenomenon of the multipath light originating from the directly reflected light RLd becoming mixed in will be described with reference to FIGS. 8A and 8B. FIG. 8A shows an example of light received by the light receiving region 320. As shown in FIG. 8A, a pixel 321B # in the light receiving region 320 may receive multipath light originating from the directly reflected light RLd corresponding to the light dots even though it should not receive the directly reflected light RLd corresponding to the light dots.

FIG. 8B is a diagram showing the variation in the amount of light received by each of the pixels 321 formed in the line indicated by a dotted line L in FIG. 8A. The horizontal axis of FIG. 8B indicates the pixel 321, and the vertical axis indicates the amount of light. As shown in FIG. 8B, there are large differences in the amount of charge stored between the pixel groups, namely, a pixel group X made up of five pixels formed to the right along the line from a pixel 321B-Ls at the left end of the line, a pixel group Y made up of the sixth to tenth pixels, and a pixel group Z made up of the eleventh pixel to a pixel 321B-Le at the right end of the line.

Specifically, the amount of charge stored in each charge storage CS in the pixel group X is approximately the same as that stored in the charge storage CS in the pixel group Z, and there is substantially no difference between them. For example, a difference D1 between the amounts of charge stored in the pixel 321B-L1 and the pixel 321B-L2 adjacent to the pixel 321B-L1 is ±1% or less with respect to the amount of charge stored in the pixel 321B-L1.

In contrast, the amounts of charge stored in the charge storages CS in the pixel group Y are greater than those in the pixel groups X and Z. For example, a difference D2 between the amounts of charge stored in the pixel 321B-L3 and the pixel 321B-L4 adjacent to the pixel 321B-L3 is ±3% or more with respect to the amount of charge stored in the pixel 321B-L3. This is considered to be because the pixel group Y received multipath light originating from the directly reflected light RLd.

Similarly to the originally expected multipath reflected light RLm, such multipath light originating from the directly reflected light RLd is received later than the directly reflected light RLd and has a greater amount of light than the originally expected multipath reflected light RLm as shown in FIG. 8B. This may cause a large error in distance calculation.

To address this issue, in this embodiment, pixels 321 that received multipath light originating from the directly reflected light RLd are not used as the pixels 321B. Specifically, the range computing unit 42 does not use, among adjacent pixels 321B, pixels 321 that have larger amounts of charge stored in their charge storages CS than the other pixels 321 as the pixels 321B.

Specifically, the range computing unit 42 acquires signal values corresponding to the amounts of charge stored in the charge storages CS for each adjacent pixel group, for example, for each line of pixels, formed at positions to be used as the pixels 321B. The range computing unit 42 determines whether to use the pixels 321 included in a pixel group as the pixels 321B based on the acquired signal values. For example, the range computing unit 42 uses the acquired signal values to calculate the average amount of charge (simple arithmetic average) stored in each charge storage CS. Based on the calculated average, the range computing unit 42 sets a threshold, for example, a value obtained by adding 3% of the average value, which is the maximum margin allowed for measurement error, to the average value. The range computing unit 42 does not select, as a pixel 321B, a pixel 321 whose amount of charge stored in a charge storage CS of the pixel 321 is equal to or greater than the threshold from the group of pixels for which signal values have been acquired. That is, the range computing unit 42 does select, as a pixel 321B, a pixel 321 whose amount of charge stored in a charge storage CS of the pixel 321 is smaller than the threshold from the group of pixels for which signal values have been acquired.

This allows the range imaging apparatus 1 of the embodiment to exclude pixels 321 that have received multipath light originating from the directly reflected light RLd from the pixels 321B. Therefore, even in a situation where multipath light originating from the directly reflected light RLd is generated, such as when there is a specular-reflective floor, the multipath reflected light RLm originally expected can be accurately excluded, and thus the distance can be accurately calculated.

A range imaging method performed by the range imaging apparatus 1 will be described with reference to FIG. 9. FIG. 9 is a flowchart illustrating the flow of a process performed by the range imaging apparatus 1 according to the embodiment.

S10: The range imaging apparatus 1 drives the pixels 321. For example, the range imaging apparatus 1 drives each pixel 321 by performing a process of distributing and storing the reflected light RL into charge storages CS (charge storages CS2 and CS3 in FIGS. 6A and 6B) in the pixel 321 a storage count corresponding to one frame. S11: The range imaging apparatus 1 acquires a signal value VA corresponding to the amount of charge (amount of charge QA) stored in each charge storage CS in a pixel 321A (pixel A). The range imaging apparatus 1 reads out a signal value corresponding to the amount of charge stored in each charge storage CS in the pixel 321A during a readout period that occurs after driving the pixel 321 in S1. The range imaging apparatus 1 thus acquires the signal values VA. More specifically, the range imaging apparatus 1 acquires a signal value VA1 corresponding to the amount of charge (amount of charge QA1) stored in the charge storage CS1 in the pixel 321A. The range imaging apparatus 1 acquires a signal value VA2 corresponding to the amount of charge (amount of charge QA2) stored in the charge storage CS2 in the pixel 321A. The range imaging apparatus 1 acquires a signal value VA3 corresponding to the amount of charge (amount of charge QA3) stored in the charge storage CS3 in the pixel 321A.

S12: The range imaging apparatus 1 acquires a signal value VB corresponding to the amount of charge (amount of charge QB) stored in each charge storage CB in a pixel 321B (pixel B). The range imaging apparatus 1 reads out a signal value corresponding to the amount of charge stored in each charge storage CS in the pixel 321B during a readout period that occurs after driving the pixel 321 in S1. The range imaging apparatus 1 thus acquires the signal values VA. More specifically, the range imaging apparatus 1 acquires a signal value VB1 corresponding to the amount of charge (amount of charge QB1) stored in the charge storage CS1 in the pixel 321B. The range imaging apparatus 1 acquires a signal value VB2 corresponding to the amount of charge (amount of charge QB2) stored in the charge storage CS2 in the pixel 321B. The range imaging apparatus 1 acquires a signal value VB3 corresponding to the amount of charge (amount of charge QB3) stored in the charge storage CS3 in the pixel 321B.

S13: The range imaging apparatus 1 calculates a signal value V by subtracting the signal value VB from the signal value VA. More specifically, the range imaging apparatus 1 calculates a signal value V2 by subtracting the signal value VB2 from the signal value VA2. The range imaging apparatus 1 calculates a signal value V3 by subtracting the signal value VB3 from the signal value VA3.

S14: The range imaging apparatus 1 calculates the distance using the signal values V (signal values VA2 and V3) calculated in S13. For example, the range imaging apparatus 1 calculates the distance using equation (3). In this case, the signal values V are substituted for the amounts of charge Q in equation (3). Specifically, the signal value V1 is substituted for the amount of charge Q1 in equation (3). The signal value V1 is a signal value corresponding to the amount of charge stored in the charge storage CS1 in the pixel 321 (which may be a pixel 321A or 321B). In addition, the signal value V2 is substituted for the amount of charge Q2 in equation (3), and the signal value V3 is substituted for the amount of charge Q3 in equation (3). The range imaging apparatus 1 terminates the measurement process.

As described above, in the range imaging apparatus 1 of this embodiment, pixels 321 are formed in a two-dimensional matrix. The light pulse PO is structured light made up of light dots. The range computing unit 42 calculates the distance to the subject OB using a value obtained by subtracting the amount of charge QB from the amount of charge QA (first amount of charge). The amount of charge QA is the amount of charge stored in a charge storage CS in the pixel 321A (first pixel circuit) that receives the directly reflected light RLd. The amount of charge QB is the amount of charge stored in a charge storage CS in the pixel 321B (second pixel circuit) that does not receive the directly reflected light RLd.

This allows the range imaging apparatus 1 of the embodiment to remove the amount of light corresponding to the multipath reflected light RLm from the amount of light that is a mixture of the directly reflected light RLd and the multipath reflected light RLm. Therefore, it is possible to suppress the influence of the multipath reflected light RLm, which is a potential cause of error, and calculate the distance accurately.

In the range imaging apparatus 1 of the embodiment, the amount of charge QB (second amount of charge) may be calculated using pixels 321B (second pixel circuits). By using pixels 321B, the noise contained in the charges and variation in the amount of received light can be reduced.

In the range imaging apparatus 1 of the embodiment, the range computing unit 42 may select a pixel 321 (pixel circuit) located at a position that is one pixel or more away from the reference position in a diagonal direction as the pixel 321B (second pixel circuit).

In the range imaging apparatus 1 of the embodiment, the range computing unit 42 may select a pixel 321 (pixel circuit) located at a position that is one pixel or more away from the reference position in the horizontal or vertical direction as the pixel 321B (second pixel circuit).

The reference position is the position of the pixel 321A (first pixel circuit) having a charge storage CS with the largest amount of charge among the amounts of charge stored in of the charge storages CS of pixels 321A (first pixel circuits).

This allows the range imaging apparatus 1 of the embodiment to use a pixel 321 close to the position of a pixel 321A as the pixel 321B. That is, it is possible to use pixels 321 (pixels 321A and 321B) that are expected to receive approximately the same amount of multipath reflected light RLm. Therefore, it is possible to accurately eliminate the influence of the multipath reflected light RLm and calculate the distance accurately.

In the range imaging apparatus 1 of the embodiment, the range computing unit 42 calculates the amount of charge QB (second amount of charge) by weighting the amount of charge stored in a charge storage CS in each pixel 321B (second pixel circuit), the weight depending on the position of the pixel 321B (second pixel circuit). By doing so, in the range imaging apparatus 1 of this embodiment, even when pixels 321 in the light receiving region 320 each receive a different amount of multipath reflected light RLm depending on the position of the pixel 321, the amounts of multipath reflected light RLm can be equalized. Therefore, even in a situation where the pixels 321 (pixels 321-3 and 321-4 in FIG. 7) in the lower part of the light receiving region 320 are more affected by the multipath reflected light RLm than the pixels 321 (pixels 321-1 and 321-2 in FIG. 7) in the upper part due to multipath reflected light RLm that has arrived via the floor or the like, variation in the influence thereof can be suppressed.

In the range imaging apparatus 1 of the embodiment, when second pixel circuits are used, and the difference between the amounts of charge stored in the corresponding charge storages CS of adjacent pixels 321 is equal to or greater than a threshold, the range computing unit 42 does not select the pixel 321 between these adjacent pixels 321 that has the larger amount of charge stored in the charge storage CS as the pixel 321B (second pixel circuit). As a result, in the range imaging apparatus 1 of this embodiment, even if a pixel 321 that has received multipath light different from the originally expected multipath reflected light RLm, such as the pixel 321B # shown in FIG. 8A, is included, it is possible to exclude the influence of the multipath light different from the originally expected multipath reflected light RLm. Therefore, the distance can be calculated accurately even if multipath light different from the originally expected multipath reflected light RLm is received.

All or part of the range imaging apparatus 1 and the range image processing unit 4 according to the above-described embodiment may be achieved by a computer. In this case, a program that achieves this function may be recorded on a computer-readable recording medium so that a computer system can read and run the program recorded on the recording medium. The “computer system” referred to herein includes an operating system (OS) and hardware such as peripheral devices. The “computer-readable recording medium” refers to a storage device such as a portable medium, e.g., a flexible disk, a magneto-optical disk, a ROM, a CD-ROM or the like, or a hard disk incorporated in the computer system. The “computer-readable recording medium” may include a medium that dynamically retains a program for a short period of time, such as a communication line that transmits a program through a network such as the internet or a telecommunication line such as a telephone line, or a medium that retains the program for a given period of time in that case, such as a volatile memory of a computer system that serves as a server or a client. The above programs may achieve part of the functions described above or may achieve the functions in combination with programs already recorded in a computer system or may achieve the functions by using a programmable logic device, such as an FPGA.

An embodiment of the present invention has been specifically described so far referring to the drawings. However, the specific configurations should not be limited to the embodiment but may include designs within the scope not departing from the spirit of the present invention.

According to an embodiment of the present invention, the influence of the multipath reflected light can be suppressed.

Time-of-flight (hereinafter referred to as “TOF”) range imaging apparatuses use the speed of light to measure the distance between the measurement device and an object based on the time of flight of light in a space (measurement space) (see, for example, JP 4235729 B). Such range imaging apparatuses determine the delay time from when a light pulse was emitted to when the light pulse reflected from the subject returns by receiving the reflected light with an imaging element, and then distributing and storing a charge corresponding to the amount of reflected light into charge storages. The distance to the subject is calculated using the delay time and the speed of light.

However, the imaging element receives not only light (directly reflected light) that is directly received after being emitted from the light source and reflected from the subject, but also light (multipath reflected light) that has been reflected from the floor or wall before being reflected from the subject and received. This multipath reflected light has an optical path length longer than that of the directly reflected light since it reaches the imaging element after being reflected from the floor or wall and enters the imaging element later than the directly reflected light. If the multipath reflected light enters the imaging element, it may not be possible to calculate the distance accurately. In addition, the imaging element receives a mixture of directly reflected light and multipath reflected light. For this reason, it is difficult to extract only the directly reflected light component from the amount of charge stored in a charge storage. In particular, when the distance to a subject (distant object) located far away from the range imaging apparatus is to be measured, the light pulse tends to be diffused before it reaches the subject. This results in a problem that the influence of multipath reflected light is greater than when measuring the distance to a nearby subject (near object).

A range imaging apparatus and a range imaging method according to embodiments of the present invention reduce the influence multipath reflected light.

A range imaging apparatus according to an embodiment of the present invention includes: a light source unit that emits a light pulse to a subject; a light receiving unit including pixel circuits formed in a two-dimensional matrix, the pixel circuits having a photoelectric conversion device that generates charge corresponding to incident light and N (N≥3) charge storages that stores the charge, and a pixel driver circuit that distributes and stores the charge into the charge storages at a storage timing synchronized with the emission of the light pulse; and a range computing unit that calculates a distance to the subject based on an amount of charge stored in each of the charge storages, in which the light pulse is structured light made up of light dots, and the range computing unit calculates the distance to the subject by using a value obtained by subtracting, from a first amount of charge stored in the charge storage in a first pixel circuit that receives directly reflected light, a second amount of charge based on an amount of charge stored in the charge storage in a second pixel circuit that is located near the first pixel circuit and does not receive the directly reflected light.

In the range imaging apparatus, the range computing unit may calculate the second amount of charge using the amount of charge stored in the charge storage in each of the second pixel circuits.

In the range imaging apparatus, the range computing unit may use, as a reference, a position of the first pixel circuit having the charge storage with a largest amount of charge among amounts of charge stored in the charge storages of first pixel circuits, and select the pixel circuit located at a position one or more pixels away from the reference position in a diagonal direction as the second pixel circuit.

In the range imaging apparatus, the range computing unit may use, as a reference, a position of the first pixel circuit having the charge storage with a largest amount of charge among amounts of charge stored in the charge storages of first pixel circuits, and select the pixel circuit located at a position one or more pixels away from the reference position in a vertical or horizontal direction as the second pixel circuit.

In the range imaging apparatus, the range computing unit may calculate the second amount of charge using a weighted value of an amount of charge stored in the charge storage of the second pixel circuit, according to the position of the second pixel circuit.

In the range imaging apparatus, when second pixel circuits are used, and a difference between amounts of charge stored in the charge storages of adjacent ones of the pixel circuits may be equal to or greater than a threshold, the range computing unit may not select the pixel circuit that has a larger amount of charge stored in the charge storage as the second pixel circuit.

A range imaging method according to an embodiment of the present invention is performed by a range imaging apparatus including: a light source unit that emits a light pulse to a subject; a light receiving unit including pixel circuits formed in a two-dimensional matrix, the pixel circuits having a photoelectric conversion device that generates charge corresponding to incident light and N (N≥3) charge storages that stores the charge, and a pixel driver circuit that distributes and stores the charge into the charge storages at a storage timing synchronized with the emission of the light pulse; and a range computing unit that calculates a distance to the subject based on an amount of charge stored in each of the charge storages, in which the light pulse is structured light made up of light dots, and the range computing unit calculates the distance to the subject by using a value obtained by subtracting, from a first amount of charge stored in the charge storage in a first pixel circuit that receives directly reflected light, a second amount of charge based on an amount of charge stored in the charge storage in a second pixel circuit that is located near the first pixel circuit and does not receive the directly reflected light.

According to an embodiment of the present invention, the influence of the multipath reflected light can be suppressed.

Obviously, numerous modifications and variations of the present invention are possible in light of the above teachings. It is therefore to be understood that within the scope of the appended claims, the invention may be practiced otherwise than as specifically described herein.

1. A range imaging apparatus, comprising:
a light source configured to emit a light pulse to a subject;
a light receiving unit comprising a plurality of pixel circuits and a pixel driver circuit; and
a range computing unit comprising circuitry configured to calculate a distance to the subject based on an amount of charge,
wherein the plurality of pixel circuits in the light receiving unit is formed in a two-dimensional matrix and has a photoelectric conversion device configured to generate charge corresponding to incident light and a plurality of charge storages configured to store the charge such that the charge storages are N charge storages where the N≥3, the pixel driver circuit in the light receiving unit is configured to distribute and store the charge into the charge storages at a storage timing synchronized with emission of the light pulse, the circuitry of the range computing unit is configured to calculate the distance to the subject based on the amount of charge stored in each of the charge storages, the light pulse is structured light comprising a plurality of light dots, and the circuitry of the range computing unit is configured to calculate the distance to the subject by using a value obtained by subtracting a second amount of charge based on an amount of charge stored in a second one of the charge storages in a second pixel circuit of the pixel circuits from a first amount of charge stored in a first one of the charge storages in a first pixel circuit of the pixel circuits such that the first pixel circuit receives directly reflected light and the second pixel circuit is formed near the first pixel circuit and does not receive the directly reflected light.

2. The range imaging apparatus according to claim 1, wherein the circuitry of the range computing unit is configured to calculate the second amount of charge using the amount of charge stored in the second one of the charge storages in each of second pixel circuits formed near the first pixel circuit and do not receive the directly reflected light.

3. The range imaging apparatus according to claim 1, wherein the circuitry of the range computing unit is configured to use, as a reference, a position of the first pixel circuit having the first one of the charge storages with a largest amount of charge among amounts of charge stored in the charge storages of a plurality of first pixel circuits and select a pixel circuit at a position one or more pixels away from the reference position in a diagonal direction as the second pixel circuit.

4. The range imaging apparatus according to claim 1, wherein the circuitry of the range computing unit is configured to use, as a reference, a position of the first pixel circuit having the charge storage with a largest amount of charge among amounts of charge stored in the charge storages of a plurality of first pixel circuits and select a pixel circuit at a position one or more pixels away from the reference position in a vertical or horizontal direction as the second pixel circuit.

5. The range imaging apparatus according to claim 1, wherein the circuitry of the range computing unit is configured to calculate the second amount of charge using a weighted value of an amount of charge stored in the charge storage of the second pixel circuit and an added weight depends on a position of the second pixel circuit.

6. The range imaging apparatus according to claim 1, wherein when a plurality of second pixel circuits that is formed near the first pixel circuit and does not receive the directly reflected light is used, and a difference between amounts of charge stored in the charge storages of adjacent ones of the pixel circuits is equal to or greater than a threshold, the circuitry of the range computing unit is configured to not select a pixel circuit that has a larger amount of charge stored in the charge storage as the second pixel circuit.

7. The range imaging apparatus according to claim 2, wherein the circuitry of the range computing unit is configured to use, as a reference, a position of the first pixel circuit having the first one of the charge storages with a largest amount of charge among amounts of charge stored in the charge storages of a plurality of first pixel circuits and select a pixel circuit at a position one or more pixels away from the reference position in a diagonal direction as the second pixel circuit.

8. The range imaging apparatus according to claim 2, wherein the circuitry of the range computing unit is configured to use, as a reference, a position of the first pixel circuit having the charge storage with a largest amount of charge among amounts of charge stored in the charge storages of a plurality of first pixel circuits and select a pixel circuit at a position one or more pixels away from the reference position in a vertical or horizontal direction as the second pixel circuit.

9. The range imaging apparatus according to claim 2, wherein the circuitry of the range computing unit is configured to calculate the second amount of charge using a weighted value of an amount of charge stored in the charge storage of the second pixel circuit and an added weight depends on a position of the second pixel circuit.

10. The range imaging apparatus according to claim 2, wherein when a plurality of second pixel circuits that is formed near the first pixel circuit and does not receive the directly reflected light is used, and a difference between amounts of charge stored in the charge storages of adjacent ones of the pixel circuits is equal to or greater than a threshold, the circuitry of the range computing unit is configured to not select a pixel circuit that has a larger amount of charge stored in the charge storage as the second pixel circuit.

11. A range imaging method, comprising:
emitting a light pulse to a subject from a light source unit of a range imaging apparatus; and
calculating a distance to the subject by using a range computing unit of the range imaging apparatus,
wherein the range imaging apparatus includes the light source configured to emit the light pulse to the subject, a light receiving unit comprising a plurality of pixel circuits and a pixel driver circuit, and the range computing unit comprising circuitry configured to calculate the distance to the subject based on an amount of charge, the pixel circuits in the light receiving unit are formed in a two-dimensional matrix and have a photoelectric conversion device configured to generate charge corresponding to incident light and a plurality of charge storages configured to store the charge such that the charge storages are N charge storages where the N≥3, the pixel driver circuit in the light receiving unit is configured to distribute and store the charge into the charge storages at a storage timing synchronized with emission of the light pulse, the circuitry of the range computing unit is configured to calculate the distance to the subject based on the amount of charge stored in each of the charge storages, the light pulse is structured light comprising a plurality of light dots, and the circuitry of the range computing unit is configured to calculate the distance to the subject by using a value obtained by subtracting a second amount of charge based on an amount of charge stored in a second one of the charge storages in a second pixel circuit of the pixel circuits from a first amount of charge stored in a first one of the charge storages in a first pixel circuit of the pixel circuits such that the first pixel circuit receives directly reflected light and the second pixel circuit is formed near the first pixel circuit and does not receive the directly reflected light.

12. The range imaging method of claim 11, wherein the circuitry of the range computing unit is configured to calculate the second amount of charge using the amount of charge stored in the second one of the charge storages in each of second pixel circuits formed near the first pixel circuit and do not receive the directly reflected light.

13. The range imaging method of claim 11, wherein the circuitry of the range computing unit is configured to use, as a reference, a position of the first pixel circuit having the first one of the charge storages with a largest amount of charge among amounts of charge stored in the charge storages of a plurality of first pixel circuits and select a pixel circuit at a position one or more pixels away from the reference position in a diagonal direction as the second pixel circuit.

14. The range imaging method of claim 11, wherein the circuitry of the range computing unit is configured to use, as a reference, a position of the first pixel circuit having the charge storage with a largest amount of charge among amounts of charge stored in the charge storages of a plurality of first pixel circuits and select a pixel circuit at a position one or more pixels away from the reference position in a vertical or horizontal direction as the second pixel circuit.

15. The range imaging method of claim 11, wherein the circuitry of the range computing unit is configured to calculate the second amount of charge using a weighted value of an amount of charge stored in the charge storage of the second pixel circuit and an added weight depends on a position of the second pixel circuit.

16. The range imaging method of claim 11, wherein when a plurality of second pixel circuits that is formed near the first pixel circuit and does not receive the directly reflected light is used, and a difference between amounts of charge stored in the charge storages of adjacent ones of the pixel circuits is equal to or greater than a threshold, the circuitry of the range computing unit is configured to not select a pixel circuit that has a larger amount of charge stored in the charge storage as the second pixel circuit.

17. The range imaging method of claim 12, wherein the circuitry of the range computing unit is configured to use, as a reference, a position of the first pixel circuit having the first one of the charge storages with a largest amount of charge among amounts of charge stored in the charge storages of a plurality of first pixel circuits and select a pixel circuit at a position one or more pixels away from the reference position in a diagonal direction as the second pixel circuit.

18. The range imaging method of claim 12, wherein the circuitry of the range computing unit is configured to use, as a reference, a position of the first pixel circuit having the charge storage with a largest amount of charge among amounts of charge stored in the charge storages of a plurality of first pixel circuits and select a pixel circuit at a position one or more pixels away from the reference position in a vertical or horizontal direction as the second pixel circuit.

19. The range imaging method of claim 12, wherein the circuitry of the range computing unit is configured to calculate the second amount of charge using a weighted value of an amount of charge stored in the charge storage of the second pixel circuit and an added weight depends on a position of the second pixel circuit.

20. The range imaging method of claim 12, wherein when a plurality of second pixel circuits that is formed near the first pixel circuit and does not receive the directly reflected light is used, and a difference between amounts of charge stored in the charge storages of adjacent ones of the pixel circuits is equal to or greater than a threshold, the circuitry of the range computing unit is configured to not select a pixel circuit that has a larger amount of charge stored in the charge storage as the second pixel circuit.
